(19) United States
(12) Patent Application Publication
(10) Pub. No.: US 2017/0361406 A1
(43) Pub. Date: Dec. 21, 2017

(54) Orbital Friction Surfacing of Remanufactured Cast-Iron Components

(71) Applicant: Caterpillar Inc., Peoria, IL (US)

(72) Inventor: Dale C. Grigorenko, Corinth, MS (US)

(73) Assignee: Caterpillar Inc., Peoria, IL (US)

(21) Appl. No.: 15/184,200

(22) Filed: Jun. 16, 2016

(51) Int. Cl. B23P 6/00; B23K 20/12; B23K 20/26

(52) U.S. Cl. CPC B23P 6/00; B23K 20/26; B23K 20/1215; B23K 20/129

(57) ABSTRACT

The method of orbital friction surfacing of components using a consumable solid tool comprises rotating the consumable featureless solid tool, plunging the tool toward a component until a desired spindle force is attained, and moving the component relative to the tool to lay down a deposition of material.

### TECHNICAL FIELD

The present disclosure relates to remanufacturing or refurbishing of cast-iron components. More specifically, the present disclosure relates to such methods for remanufacturing cast-iron components that use orbital friction to lay down new material that may be used to repair the components.

### BACKGROUND

Cast-iron components are used in many industries but have been particularly useful in machinery used in construction, earth-moving and the like as well as engine components. As can be imagined, wear or damage may occur to these cast-iron components over time that may cause them to become unusable due being out of tolerance or excessively damaged. These components may be expensive to manufacture from raw materials and/or it may be useful to fix such components in the field if there is a scarcity of replacement components. In either case, it is desirable to be able to remanufacture or refurbish the component to save time or money.

Previous methods used for remanufacturing such components include conventional metallurgical bond methods and welding. However, these methods may require a high preheat temperature that can leave an undesirable high hardness heat affected zone. Therefore, these methods often create some sort of compromised metallurgical structure that may lead to cracking of the base material. As a result, the cast-iron component may need rework sooner than is desired.

### SUMMARY OF THE DISCLOSURE

A machine for orbital friction surfacing of components that defines a Cartesian coordinate system including X, Y and Z axes is provided. The machine comprises at least one component that is movable along the X and Y axes and at least another component that is movable along the Z axis, a rotating spindle, a motor that powers the spindle, a tool attachment mechanism that is operatively associated with the rotating spindle, a position sensor and force transducer that are in communication or operative association with the spindle, and a controller that is configured to sense the position of the spindle via the position sensor and the force exerted on the spindle via the force transducer and to move at least one component that is movable along any of the X, Y and Z axes in order to maintain a desirable force exerted on the spindle.

The method of orbital friction surfacing of components using a consumable featureless solid tool comprises rotating the consumable featureless solid tool, plunging the tool toward a component until a desired spindle force is attained, and moving the component relative to the tool to lay down a deposition of material.

### BRIEF DESCRIPTION OF THE DRAWINGS

FIG. 1 is a perspective view of a CNC milling machine that is capable of at least three axis linear movement and rotation of a tool for performing machining operations on a workpiece.

FIG. 2 is a perspective view of a consumable rod according to an embodiment of the present disclosure that may be attached to the spindle of the milling machine of FIG. 1 using a tool adapter and collet tool retaining mechanism.

FIG. 3 is partial front cross-sectional view of a tool adapter with a set screw tool retaining mechanism holding a consumable rod that may be attached to the spindle of the milling machine of FIG. 1.

FIG. 4 is a simplified perspective view showing the use of a solid consumable rod that is used in a method of orbital friction surfacing of remanufactured cast-iron components.

FIG. 5 is a flowchart depicting various steps of a method or process in accordance with an embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or a prime indicator such as 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters or primes will often not be included herein but may be shown in the drawings to indicate duplications of features discussed within this written specification.

Orbital friction surfacing may be achieved by the rotation motion of one consumable solid tool as it traverses across the surface of a workpiece that is intended to be remanufactured or refurbished. The surface of the workpiece may be perpendicular to the axis of rotation of the consumable solid tool. During the process, the material may be deposited in a solid state mode, thereby drastically reducing the heat input, which has the effect of mitigating distortion, reducing or eliminating cracking, reducing or eliminating the requirement for preheat of the workpiece component, and reducing or eliminating dilution between the substrate and the consumable tool. This may enable the salvage of cast iron engine components currently deemed “unsalvageable” due to the aforementioned effects of conventional welding processes. These components may be, but are not limited to: engine heads, blocks, turbochargers, exhaust components, etc. This may also be used on work tools such as buckets, tips, and the like, etc. It is contemplated that the machine and method described herein may be adapted for use with other materials as well.

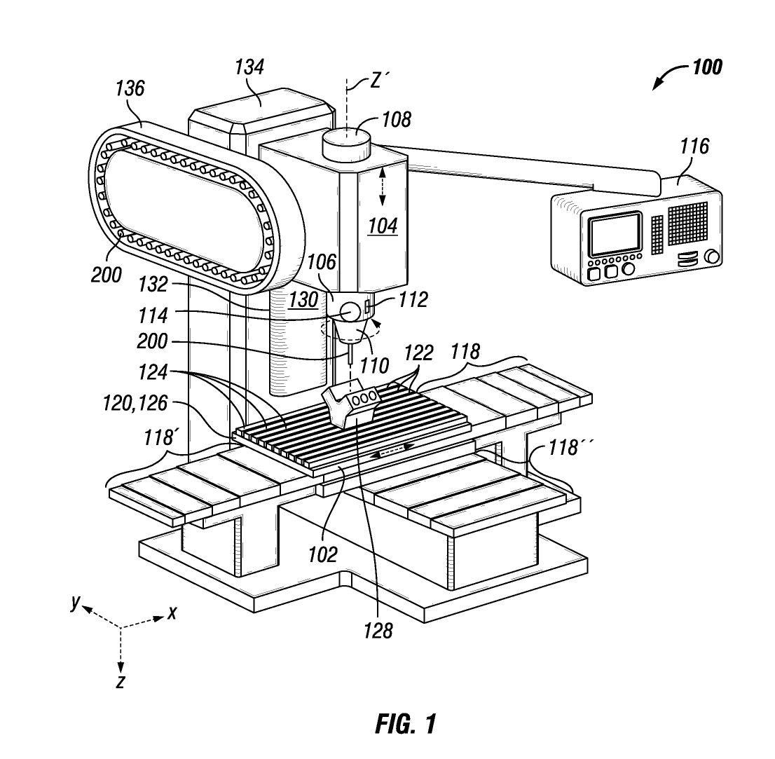

Looking at FIG. 1, it depicts a machine that may be used for orbital friction surfacing of components. The machine 100 defines a Cartesian coordinate system including X, Y and Z axes and happens to be a CNC programmable machine. The machine 100 comprises at least one component 102 that is movable along the X and Y axes and at least another component 104 that is movable along the Z axis, a rotating spindle 106, a motor 108 that powers the spindle 106, a tool attachment mechanism 110 that is operatively associated with the rotating spindle 106 for powering the rotation of the spindle 106, a position sensor 112 and force transducer 114 that are in communication or operative association with the spindle 106, and a controller 116. The controller 116 is configured to sense the position of the spindle via the position sensor 112 and the force exerted on or by the spindle 106 via the force transducer 114 and to move at least one component 102, 104 that is movable along any of the X, Y and Z axes in order to maintain a desirable force exerted on or by the spindle 106. A consumable solid tool 200 is attached to the tool attachment mechanism 110 that will be described in further detail later herein.

Still referring to FIG. 1, the machine comprises a table or bed 102 that is configured to translate along the X and Y axes. A series of collapsible and expandable plates 118 are located on each side of the bed 102 along the X axis that protect mechanisms used to move the bed 102. The plates 118 on the right side of the bed 102 in FIG. 1 will collapse when the bed 102 moves in the positive X direction and will expand when the bed moves in the negative X direction. Contrarily, the plates 118′ on the left side of the bed in FIG. 1 will expand when the bed 102 moves in the positive X direction and contract when the bed 102 moves in the negative X direction. Another series of plates 118″ are positioned forward of the bed 102 along the negative Y axis that expand when the bed 102 moves in the positive Y direction and contract when the bed 102 moves in the negative Y direction.

Typically, a workpiece attachment mechanism 120 is attached to the bed 102 such as a vise or the like using the dovetail shaped grooves 122 that separate the rails 124 of the bed 102. Alternatively, a workpiece may be clamped down on the bed to hold it in place using clamps that have fingers that press on top of the workpiece using a fastener that connect the fingers to holding members that are retained in the dovetail shaped grooves. When a ferrous workpiece is used such as steel, cast-iron, etc., a magnetic chuck 126 may be employed that uses electromagnets that are embedded in the rails 124 of the bed 102 and hold the workpiece 128 in place once activated. For the embodiment shown in FIG. 1, such a magnetic chuck 126 is being shown used to hold a cast-iron workpiece 128 in place. In such a case, the grooves 122 may be omitted, allowing the bed 102 to have a continuous flat surface.

As shown in FIG. 1, the spindle 106 is configured to translate along the Z axis and to rotate about a Z′ axis, which is parallel with the Z axis. The spindle 106 is attached to head 104 that is movably attached to a vertical guide rail 130 that defines dovetail shaped grooves 132 between the support column 134 of the machine and the vertical guide rail 130. A rack and pinion mechanism or another similar mechanism (not shown) may allow the head 104 and spindle 106 to translate up and down along the vertical guide rail 130 in a direction parallel to the Z axis. As mentioned previously, the bed 102 is able to move in the X and Y directions. It is contemplated that these roles of the head and bed may be reversed in other embodiments and other movable components and other more complex movements may be provided in yet further embodiments.

A tool attachment mechanism 110 is shown at the bottom of the spindle 106 and is fixed to the spindle 106 such that any rotation of the spindle 106 is imparted to the tool attachment mechanism 110 and a tool 200 that is attached to that mechanism. The tool attachment mechanism 110 may take any form known or that will be devised in the art including a chuck or a tool adapter 134 that is configured to hold the tool 200 and be readily attached and detached from the machine 100 in a manner that will be described in more detail later. For the embodiment shown in FIG. 1, a tool adapter 134 is used and the machine 100 further comprises a tool adapter indexer 136 that allows tool adapters and tools 200 to be changed when worn or when a different tool is desired to be used to perform work on the workpiece 128.

The controller 116 in FIG. 1 may be of any type known or that will be devised in the art and may use any type of processing device, digital logic, etc. to control the various movements and functions of the machine 100. For this embodiment, the controller may be an Allen Bradley or similar type controller that is configured to monitor the wear of the consumable solid tool 200 until the wear reaches a threshold. At which time, the tool adapter indexer 136 may be activated to move and change out the worn tool 200, replacing that tool with a fresh tool. Alternatively, a signal may be given alerting an operator to change the tool out.

During set up, an operator may install the workpiece 128 such that it is held by the workpiece attachment mechanism and may make certain dimensional measurements that will be discussed in more detail momentarily. Then, the operator may enter these measurements or variables into the controller 116, which is configured to receive input of the variables and calculate the appropriate operating parameters of the machining process to be performed on that workpiece. Alternatively, the measurements and data input may be performed by another technician remotely from the machine such as during tool setup and the data input and calculations may be downloaded to the machine. Examples of input data include, but are not limited to, the diameter of the tool, the material of the tool, the length of extension of the tool from the tool attachment mechanism, etc. Examples of calculated machine parameters include, but are not limited to, linear feed rate of the workpiece, force exerted by the spindle, rotational speed of the spindle, etc.

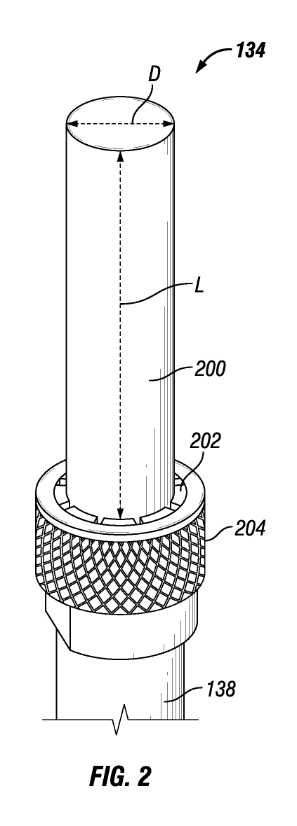

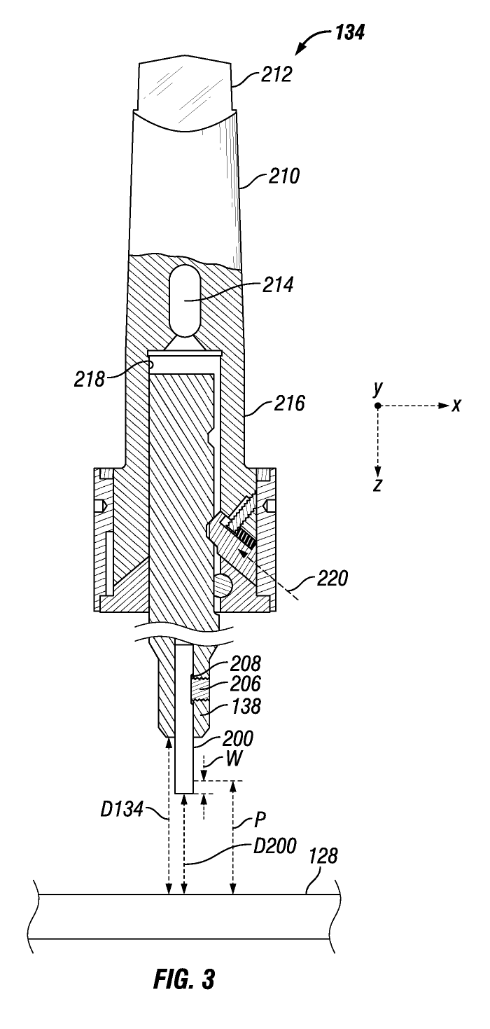

Turning now to FIGS. 2 and 3, details of the consumable solid tool 200, methods of attachment to a tool adapter 134, and pertinent dimensions are shown in more detail and will be discussed. FIG. 2 is a perspective fragmentary view of a consumable solid tool 200 that extends upwardly from the extension portion 138 of a tool adapter 134. As shown, the tool 200 points upward instead of downward but the orientation of the tool 200 may be varied as needed or desired depending on a particular application such as the configuration of the machine 100 being used. As can be seen, the tool 200 has a cylindrical configuration but this may be varied as needed or desired. A collar/collet retention mechanism is shown holding the tool 200 in place such that the tool 200 is retained by the tool adapter, fixing the Z position of the tool 200 relative to the tool adapter 134 (see FIG. 1). The collet 202 is only partially shown but is to be understood to be made of a unitary piece made from a spring steel type of material with a cam surface and slits. The collar 204 is threadedly attached to the extension 138 of the tool adapter 134. As the collar 204 is tightened, its cam surface (not shown) contacts the cam surface of the collet, causing the collet to collapse as the slits are contracted, until the inner diameter of the collet 202 clamps onto the outer diameter D of the tool 200, fixing its position rotationally and translatably. The pertinent dimensions that may affect the process are shown in FIG. 2 to include the diameter D of the tool 200, the length L of extension of the tool 200, and the material from which the tool is made (not shown).

As illustrated by FIG. 2, the term “consumable solid tool” means herein that the tool is meant to add material to a workpiece rather than remove it as is the case with conventional tools such as end mills and drills. Hence, the tool is a sacrificial item instead of the workpiece. Furthermore, the tool is in a solid state, that is to say, it is not molten anywhere between the workpiece and the tool adapter except for the small layer being deposited on the workpiece as will be described in more detail later herein. Also, the solid tool may be characterized as lacking features typically associated with cutting tools such as flutes, cutting edges, cutting points, apertures, angled features for facilitating the creation and removal of chips, etc. Hence, the consumable solid tool may be considered featureless. The type of material used to make the tool may vary as needed or desired but it is contemplated that tool may be made from a Nickel-Iron alloy when the workpiece is made from cast-iron.

FIG. 3 shows another tool adapter 134 that uses a set screw 206 that interfaces with a notch 208 on the side of the tool 200 to hold the tool 200 in position. FIG. 3 also shows some distances between various parts of the tool 200 or tool adapter 134 and the workpiece 128 that are useful for setting up the machine 100 and process. The tool adapter 134 includes a tapering shank 210 that is configured to match with a tapering recess (not shown) in the spindle 106 and a flattened tang 212 that cooperates with a complimentary shaped recess (not shown) in the spindle 106 for communicating torque to the tool adapter 134. It also includes a thru-slot 214 that may be used to accept a wedge (not shown) of the spindle 106 that holds the tool adapter 134 in the spindle 106. The extension portion 138 of the tool adapter 134 extends into a pocket 218 and is held in the main body 216 of the tool adapter 134 using a retaining mechanism 220 that is known in the art. Accordingly, a detailed description of the retaining mechanism is not warranted. Alternatively, the extension portion 138 may be formed integral with the main body 216 of the tool adapter 134. Other configurations of the tool adapter are possible.

During setup, the operator may use a gauge block to measure the distance D200 from the tip of the tool to the workpiece, and enter a corresponding offset into the controller 116. This dimension D200 would correspond to the movement in the Z direction that would constitute a “soft crash” if the head 104 and spindle 106 were to move more than this distance. The controller 116 may be configured to calculate the distance D134 from the workpiece 128 to the tool adapter 134 by adding the “soft crash” dimension D200 to the length of extension L (shown in FIG. 2). This distance may be referred to as the “hard crash” dimension. Of course, it is desirable to approach the soft crash dimension slowly to avoid damage to the tool and even more desirable to avoid approaching the hard crash dimension for fear of damaging the tool adapter, spindle, head, and possibly other parts of the machine. In practice, the controller 116 may be configured to monitor the actual position P of the tip of the tool 200 in order to calculate the amount of wear W the tool 200 has experienced. As the wear occurs, the amount of force exerted by the spindle as well as other variables may be adjusted in order to achieve the desirable adhesion of added material.

As mentioned earlier, if enough wear has occurred, then the tool 200 may be changed out for a fresh tool. The amount of acceptable wear W may be expressed as a percentage of the length of extension L or as a percentage of the actual distance P of the tip of the tool 200 from the workpiece 128 versus the hard crash depth D134. For example, either of these methods may be expressed in terms of 70-90% of the length of extension L or the hard crash dimension D134 depending on the application. Other values and methods are possible.

The length of extension L may be proportional to the diameter D of the tool 200 (see FIG. 2) in order to prevent buckling of the tool that could cause the process to be halted. The rate of linear movement of the workpiece may be altered depending on the force exerted on the spindle, rate of rotation of the spindle, etc. It is further contemplated that the linear movement may occur in the X, Y and/or Z direction depending on the profile of the workpiece.

### INDUSTRIAL APPLICABILITY

In practice, a machine 100 may be sold or retrofitted with the capabilities to implement any method or process discussed herein. Similarly, a method or process as discussed herein may be used to add material to a workpiece or other component for the purpose of remanufacturing or refurbishing that component.

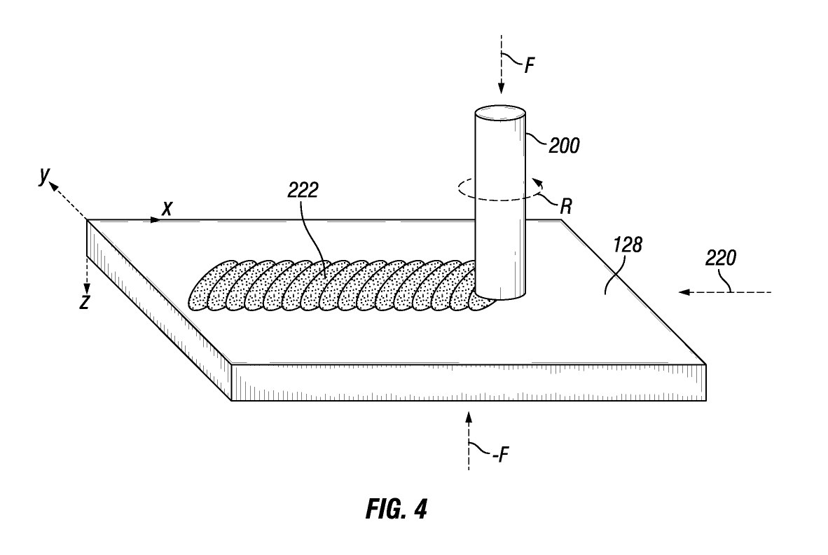

FIG. 4 illustrates the mechanics of the process from a purely conceptual viewpoint. The consumable solid tool 200 is rotated and pressed down on a component 128 while that component 128 is moved in any of the X, Y, and Z directions or combinations thereof. The combination of the force exerted F on the component 128 as well as the force −F exerted on the consumable solid tool 200, movement 220 of the component 128, and rotation R of the tool 200 deposits a thin viscous layer 222 of molten material on the component 128 at lower temperatures compared to other prior techniques, lowering the heat affected zone between the substrate 128 and deposited material 222, providing a more robust bonding of the newly deposited material 222 to the substrate 128.

It should be noted that the forces and movements of the tool and the component/workpiece may be expressed purely relative to each other. For example, the downward force exerted onto the tool may be equally and oppositely balanced by a force provided by a rigid and incompressible platform on which the bed of the machine rests, which in turn, rests on a rigid and incompressible surface such as that provided by concrete and the like. Similarly, the rotation may be imparted to the component or workpiece while the linear movement may be imparted to the tool, etc. Therefore, all language contained herein should include relative equivalents.

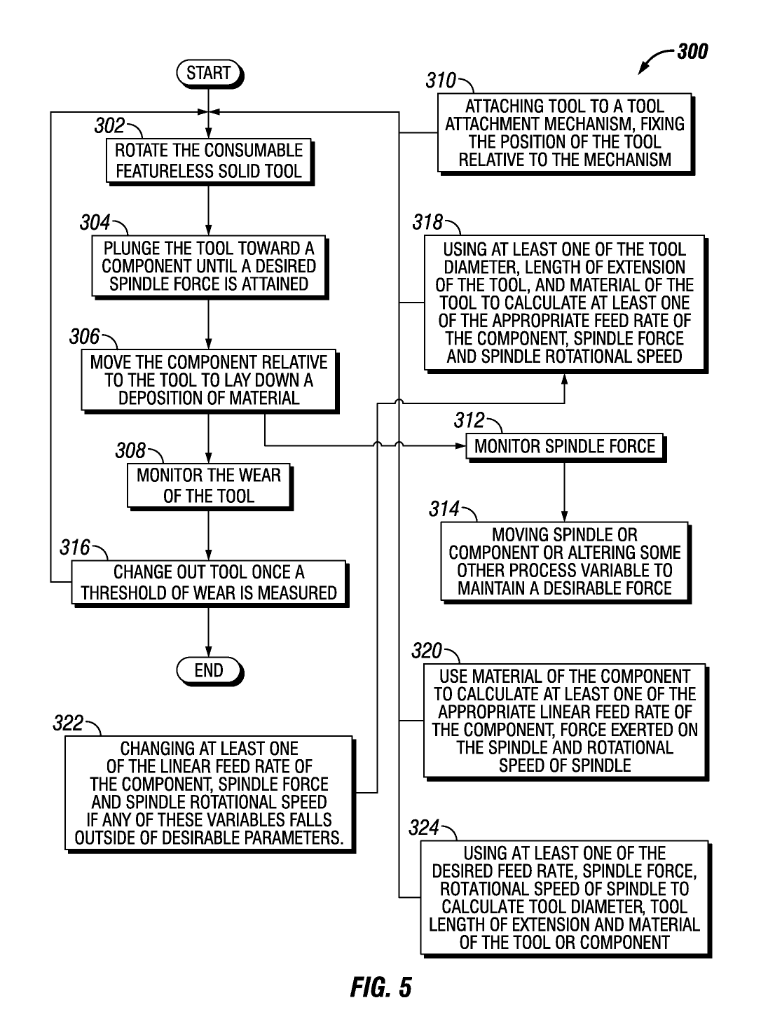

FIG. 5 contains a flowchart depicting various steps of a method for adding material to a component using orbital friction surfacing. The method 300 may comprise the steps of rotating the consumable featureless solid tool (see step 302), plunging the tool toward a component until a desired spindle force is attained (see step 304), and moving the component relative to the tool to lay down a deposition of material (see step 306).

The method 300 may further comprise monitoring the wear of the tool (see step 308) and attaching the tool to a tool attachment mechanism, fixing the position of the tool relative to the tool attachment mechanism (see step 310).

The method 300 may further comprise monitoring the spindle force (see step 312) and moving the spindle or workpiece or altering some other process variable to maintain a desirable spindle force (see step 314).

The method may further comprise changing out the tool once a threshold of wear is measured (see step 316).

In other embodiments, the method may further comprise using at least one of the tool diameter, length of extension of the tool from the tool attachment mechanism, and the material of the tool to calculate at least one of the appropriate linear feed rate of the component, appropriate force exerted on the spindle and the appropriate rotational speed of the spindle (see step 318).

The method may further comprise using the material of the component to calculate at least one of the appropriate linear feed rate of the component, force exerted on the spindle and rotational speed of the spindle (see step 320).

In yet further embodiments, the method may further comprise changing at least one of the linear feed rate of the component, force exerted on the spindle and rotational speed of the spindle if any of these variables falls outside of desirable parameters (step 322).

In some cases the desired material deposition time or machine limitations are known limits. Then, the method may comprise using at least one of the desired linear feed rate, force exerted on the spindle, and rotational speed of the spindle to calculate at least one of the appropriate tool diameter, length of extension of the tool from the tool attachment mechanism, and material of the tool or component (step 324).

It is contemplated that this method may be accomplished through experimentation using examples of tools and components made from a particular material. Specifically, the tool may be made from a nickel-iron alloy while the component may be made from cast-iron. Various variables may be tested and tables or curves fitted to the experimental data may be used by a controller to implement a process that will provide suitable results.

Exemplary values for various process values and dimensions of the tool will now be given. It is contemplated that rotational speed of the spindle may range from 150 to 2000 RPM, that the diameter of the tool may range from 0-25 mm or more, that the linear feed rate may range from 1-5 mm/s or more, that the depth of deposited material added per pass of the tool may range from 0-0.2 mm, and that the force exerted on the tool may range from 0.66-3.3 KN (150-750 lbs) or more when the substrate comprises cast-iron and the tool comprises a nickel-iron alloy. The length of extension of the tool may be calculated by avoiding the buckling load for the tool using the following equation:

L=(F/(π²EI))^{1/2} where

F=Z force on the tool, E is the modulus of elasticity of the material of the tool, I is the moment of inertia of the tool which for a circular cross-section is I=π/4(D/2)⁴. Similar calculations may be made for axial compressive stress and bending stress using equations well-known in the art. Accordingly, the verbatim recitation of these equations herein is not deemed warranted. The process may be altered as needed to avoid exceeding the compressive or bending stress as well.

These process variables and dimensions may be varied depending on the application and the materials of the substrate and the tool. As mentioned previously, experimental data may be developed to create tables or curve fits that will facilitate the optimization of the process via the controller of the machine for various applications.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A machine for orbital friction surfacing of components that defines a Cartesian coordinate system including X, Y and Z axes, the machine comprising:
at least one component that is movable along the X and Y axes and at least another component that is movable along the Z axis;
a rotating spindle;
a motor that powers the spindle;
a tool attachment mechanism that is operatively associated with the rotating spindle, a position sensor and force transducer that are in communication or operative association with the spindle; and
a controller that is configured to sense the position of the spindle via the position sensor and the force exerted on the spindle via the force transducer and to move at least one component that is movable along any of the X, Y and Z axes in order to maintain a desirable force exerted on the spindle.

2. The machine of claim 1 further comprising a consumable solid tool that is retained by the tool attachment mechanism fixing the Z position of the tool relative to the tool attachment mechanism.

3. The machine of claim 2 wherein the at least one component that is movable along the X and Y axis or the at least one component that is movable along the Z axis includes a bed, the machine further comprising a workpiece attachment mechanism that is attached to the bed.

4. The machine of claim 3, wherein the workpiece attachment mechanism includes a magnetic chuck.

5. The machine of claim 3, wherein the bed is configured to translate along the X and Y axes.

6. The machine of claim 1, wherein the spindle is configured to translate along the Z axis and to rotate about an axis that is parallel to the Z axis.

7. The machine of claim 7, wherein the tool attachment mechanism includes a tool adapter the machine further comprises a tool adapter indexer.

8. The machine of claim 2, wherein the controller is configured to monitor the wear of the consumable solid tool until the wear reaches a threshold.

9. The machine of claim 8, wherein the controller is configured to move the tool adapter indexer and change out the worn tool.

10. The machine of claim 3 further comprising a workpiece held by the workpiece attachment mechanism wherein the controller is configured to receive input of variables such as the tool diameter, length of extension of the tool from the tool attachment mechanism, and the material of the tool and to calculate the appropriate linear feed rate of the workpiece, force exerted on the spindle and rotational speed of the spindle.

11. A method of orbital friction surfacing of components using a consumable solid tool comprising:
rotating the consumable solid tool;
plunging the tool toward a component until a desired spindle force is attained; and
moving the component relative to the tool to lay down a deposition of material.

12. The method of claim 11 further comprising monitoring the wear of the tool.

13. The method of claim 11 further comprising attaching the tool to a tool attachment mechanism, fixing the position of the tool relative to the tool attachment mechanism.

14. The method of claim 11 further comprising monitoring the spindle force and moving the spindle or workpiece to maintain a desirable spindle force.

15. The method of claim 12 further comprising changing out the tool once a threshold of wear is measured.

16. The method of claim 11 further comprising using at least one of the tool diameter, length of extension of the tool from the tool attachment mechanism, and the material of the tool to calculate at least one of the appropriate linear feed rate of the component, force exerted on the spindle and rotational speed of the spindle.

17. The method of claim 16 further comprising using the material of the component to calculate at least one of the appropriate linear feed rate of the component, force exerted on the spindle and rotational speed of the spindle.

18. The method of claim 16 further comprising changing at least one of the linear feed rate of the component, force exerted on the spindle and rotational speed of the spindle if any of these variables falls outside of desirable parameters.

19. The method of claim 11 further comprising using at least one of the desired linear feed rate, force exerted on the spindle, and rotational speed of the spindle to calculate at least one of the appropriate tool diameter, length of extension of the tool from the tool attachment mechanism, and material of the tool or component.

20. The method of claim 11 wherein the tool and component comprise an cast-iron or nickel-iron alloy.
